(19) United States
(12) Patent Application Publication
(10) Pub. No.: US 2013/0158230 A1
(43) Pub. Date: Jun. 20, 2013

(54) Carbonylative Polymerization Methods

(71) Applicants: Geoffrey W. Coates, Lansing, NY (US); Erin Dunn, Ithaca, NY (US)

(72) Inventors: Geoffrey W. Coates, Lansing, NY (US); Erin Dunn, Ithaca, NY (US)

(73) Assignee: CORNELL UNIVERSITY, Ithaca, NY (US)

(21) Appl. No.: 13/805,459

(22) PCT Filed: Jun. 22, 2011
(86) PCT No.: PCT/US2011/041364

§ 371 Date: Mar. 7, 2013

Related U.S. Application Data
(60) Provisional application No. 61/357,233, filed on Jun. 22, 2010.

(51) Int. Cl. C08G 63/82

(52) U.S. Cl. CPC C08G 63/823
USPC 528/357

(57) ABSTRACT

Provided are methods forming polymers. The methods include, for example, tandem carbonylation and polymerization reactions, where epoxides are catalytically carbonylated to form lactones and the lactones catalytically polymerized to form polymers without the need to isolate or purify the lactone intermediate. Also provided are methods for catalytically polymerizing beta-propiolactone. Homopolymers and copolymers can be formed using the methods disclosed herein.

### CROSS-REFERENCE TO RELATED APPLICATIONS

This application claims priority to U.S. provisional patent application No. 61/357,233 filed Jun. 22, 2010, the disclosure of which is incorporated herein by reference.

### STATEMENT REGARDING FEDERALLY SPONSORED RESEARCH

This invention was made with government support under contract nos. CHE-0809778 and DE-FG02-05ER15687 awarded by the National Science Foundation and the Department of Energy, respectively. The government has certain rights in the invention.

### FIELD OF THE INVENTION

The present invention generally relates to methods with tandem reactions. More particularly, the present invention relates to tandem carbonylation and polymerization methods.

### BACKGROUND OF THE INVENTION

Poly(3-hydroxybutyrate) (P3HB) is a naturally occurring biodegradable and biocompatible polyester that exhibits properties similar to polyolefins. Current methods to synthesize poly(3-hydroxybutyrate) (P3HB) include bacterial fermentation, direct copolymerization of propylene oxide (PO) and carbon monoxide (CO), and ring-opening polymerization of β-butyrolactone (BBL). Fermentation produces high molecular weight P3HB with the potential to incorporate various pendant functionality into the polyester. However, the process is energy-intensive and necessitates polymer separation from the bacterial culture. In contrast, the direct copolymerization of CO and PO is atom-economical, yet it suffers from low monomer conversion and polymers of low molecular weight are generally produced. Finally, the living ring-opening polymerization of BBL yields high molecular weight polyester, although it requires the rigorous purification of a toxic lactone.

### BRIEF SUMMARY OF THE INVENTION

In an aspect, the present invention provides a method for making a polymer comprising: reacting one or more epoxides, carbon monoxide, and a carbonylation catalyst to form one or more lactones, and allowing the one or more lactones to react with a polymerization catalyst, without isolation or purification of the one or more lactones, to form a polymer. For example, the method is carried out in a single reaction vessel.

In an embodiment, the carbon monoxide is at least partially removed after formation of the one or more lactones. For example, the polymerization catalyst is added after at least 50% of the one or more epoxides is reacted to form the one or more lactones and the carbon monoxide is, optionally, removed.

In another aspect, the present invention provides a method for making a polymer comprising the steps of: reacting beta-propiolactone with a polymerization catalyst having the structure [C⁺][A⁻], where C⁺ is an organic cation or ligated metal cation, and where A⁻ is a nucleophillic anion, such that a polymer is formed. In an embodiment, C⁺ is not a tetraethyl or tetra-n-butylammonium cation when A⁻ is a pivalate anion.

Examples of suitable epoxides are ethylene oxide, propylene oxide, butene oxide, hexene oxide, styrene oxide, trifluoromethyl ethylene oxide, a glycidyl ether, or combinations thereof. In an embodiment, the one or more epoxides are ethylene oxide and propylene oxide, or propylene oxide and 1-butene oxide, and a copolymer is formed. For example, the one or more epoxides are present in optically enriched form or in the form of a racemic mixture of epoxides. The epoxides can be present in a solvent such as, for example, tetrahydrofuran, diethylether, chloroform, dichloromethane, benzene, toluene, 1,4-dioxane, and combinations thereof.

The carbonylation catalyst is, for example, a transition metal compound having the structure: [LA⁺][Co(CO)₄⁻], where LA⁺ is a Lewis acid cation. The polymerization catalyst is, for example, (BDI)ZnOR¹, where BDI is a β-diiminate ligand and R¹ is a C₁ to C₂₀ alkyl, or an alkylzinc alkoxide compound.

In an embodiment, the epoxide is ethylene oxide, and the polymerization catalyst has the structure [C⁺][A⁻], where C⁺ is an organic cation or ligated metal cation, and where A⁻ is a nucleophillic anion.

### BRIEF DESCRIPTION OF THE FIGURES

FIG. 1. In-situ IR spectroscopy of carbonylative copolymerization showing formation and subsequent conversion of β-butyrolactone intermediate to poly(3-hydroxybutyrate) (Table 2, entry 4).

FIG. 2. Example of tandem carbonylation and polymerization reactions of the present invention.

FIG. 3. Characterization of an example of a crude reaction mixture. (a) ¹H NMR spectrum of rac-BBL. (b) ¹H NMR spectrum of crude reaction mixture (Table 2, entry 6) (c) Gas chromatogram of BBL (d) gas chromatogram crude reaction mixture (Table 2, entry 6).

FIG. 4. Example of Mₙ vs. Conversion of BBL (Table 2, entry 4). Squares

FIG. 5. In-situ IR spectroscopy of carbonylative polymerization showing formation and subsequent conversion of lactone intermediate to polymer.

### DETAILED DESCRIPTION OF THE INVENTION

The present invention is based on the surprising observation that in carbonylation/polymerization of epoxides use of particular carbonylation catalysts obviates the need to isolate and/or purify the lactone product prior to reaction with a polymerization catalyst. For example, it was surprisingly observed that catalysts were identified that could catalyze carbonylation of propylene oxide to form β-butyrolactone (BBL) and polymerization of β-butyrolactone (BBL) to form poly(3-hydroxybutyrate), without isolating or purifying the β-butyrolactone (BBL).

The present invention provides methods for preparation of polymers. The methods are based on a combination of carbonylation reactions and polymerization reactions. In an embodiment, an epoxide is catalytically carbonylated and the resulting lactone catalytically polymerized. The polymers can be homopolymers or copolymers.

In an aspect, the methods of the present invention comprise a catalytic carbonylation and a catalytic polymerization reaction. The catalytic carbonylation reaction occurs first. In this reaction, an epoxide is reacted in the presence of a catalyst to form a lactone. Then, the resulting lactone is polymerized in the presence of a catalyst to form a polymer. If a single epoxide is used the polymer is a homopolymer. If two or more epoxides are used, two or more lactones are formed and the polymer is a copolymer. The methods can be carried out in a single reaction vessel (i.e., one-pot) and without isolation of intermediates, e.g., the lactone(s).

In an embodiment, the method of making a polymer comprises reacting a reaction mixture comprising one or more epoxides, carbon monoxide, and a carbonylation catalyst to form one or more lactones, wherein the one or more lactones is not isolated or purified, and reacting the at least one or more lactones with a polymerization catalyst, to form a polymer.

It may be desirable to add the polymerization catalyst after a pre-selected extent of epoxide reaction and/or amount of lactone formation (e.g., percentage based on complete conversion of epoxide to lactone). For example, the polymerization catalyst can be added after the pre-selected extent of lactone formation if the polymerization catalyst will adversely affect, e.g., poison or reduce the activity to an undesirable level, the activity of the carbonylation catalyst.

Thus, in an embodiment, the reaction can be carried out by reacting a reaction mixture comprising the epoxide(s), carbon monoxide, and the carbonylation catalyst to form the lactone(s). After formation of the lactone has proceeded to the pre-selected extent, residual carbon monoxide is allowed to at least partially or completely be removed (e.g., released) from the reaction mixture and the polymerization catalyst added to the reaction mixture. The polymerization catalyst can be added with or without a solvent (or mixture of solvents). For example, the polymerization catalyst can be added neat or in solution.

In another embodiment, the method for making a polymer comprises reacting one or more epoxides, carbon monoxide, and a carbonylation catalyst to form one or more lactones, and then allowing some or all residual carbon monoxide to be removed (e.g., released), for example, by reduction of reaction vessel pressure. Then, after the carbon monoxide level has reached a pre-selected level, adding a polymerization catalyst. In various embodiments, the pre-selected level of carbon monoxide is 1000, 500, 250, 100, 50, 25, 10, 5, 1, or 0.1 psi or less in the reaction vessel. In an embodiment, no detectible carbon monoxide is present in the reaction vessel. The carbon monoxide level can be detected by, for example, gas chromatography. As a result of the polymerization of the one or more lactones a polymer is formed.

The carbonylation reaction to form the lactone can be allowed to proceed to a desired extent prior to release of any residual carbon monoxide and addition of the polymerization catalyst. For example, the carbonylation reaction can be monitored using in situ IR spectroscopy to determine the extent of epoxide reaction and lactone formation. In various examples, the carbonylation reaction is allowed to proceed to at least 50, 60, 70, 80, 90, 95, 99, or 99.9% completion prior to addition of the polymerization catalyst. In an example, the carbonylation is allowed to proceed until there is no detectible epoxide (for example, by IR spectroscopy) prior to release of any residual carbon monoxide and addition of the polymerization catalyst.

The reaction mixture can, optionally, include a solvent (or mixture of solvents), which can be added to the reaction mixture at any point (e.g., by addition of one or more of the reactants in solution or by adding the solvent to the reaction vessel), or the reaction can be run neat (no additional solvent). A broad range of solvents can be used. For example, any solvent with suitable solubility of one or more of the reactants can be used. Examples of suitable solvents include, but are not limited to, tetrahydrofuran, alkyl ethers (e.g., diethylether), chlorinated solvents (e.g., chloroform, dichloromethane), benzene, toluene, 1,4-dioxane, or a mixture thereof. It is desirable that the solvent be an aprotic solvent.

A broad range of epoxides can be used. For example, terminal epoxides can be used. In another example a mixture of epoxides is used. Examples of suitable epoxides include, but are not limited to, ethylene oxide, propylene oxide, butene oxide, hexene oxide, styrene oxide, trifluoromethyl ethylene oxide, glycidyl ethers, or a combination thereof. Examples of suitable glycidyl ethers include, but are not limited to, methyl glycidyl ether, ethyl glycidyl ether, and phenyl glycidyl ether. It is desirable that the epoxide be a terminal, non-protic epoxide.

The epoxides can be present as mixtures of stereoisomers, where the mixture is, for example, enriched in one stereoisomer relative the complementary stereoisomer (also referred to as an optically enriched form of the epoxides) and/or racemic mixtures of epoxides. For example, the epoxides can be present as a mixture of steroisomers having greater than 90, 95, 99, 99.5, 99.9% purity of one steroisomer. In another example, optically pure (no detectible complementary steroisomer present) epoxide is used. Optical purity can be determined by, for example, nuclear magnetic resonance spectroscopy. Use of optically pure epoxides or epoxides present a mixture enriched, e.g., greater than 90% enrichment, in a stereoisomer in the methods described herein can result in formation of polymers having desirable properties. For example, optically pure propylene oxide can be used to give semi-crystalline, isotactic P3HB. As another example, optically pure propylene oxide and either optically active or racemic 1-butene oxide can be used to give a semicrystalline polymeric material with improved impact resistance.

For example, a mixture of ethylene oxide and proplene oxide can be used in the method. In another example, a mixture of butene oxide and propylene oxide can be used. Use of such mixtures will result in formation of a copolymer.

Any combination of carbonylation catalyst and polymerization catalyst where each catalyst affects catalysis without adversely affecting the catalytic reactivity of the other catalyst can be used. Such reactivity can be referred to as orthogonal reactivity.

Examples of carbonylation catalysts include, but are not limited to, compounds having the following structure:

[LA⁺][Co(CO)₄⁻].

LA⁺ is a Lewis acid cation. It is expected that a broad range of Lewis acids can be used in the present invention, with the exception that a Lewis acid that catalyzes polymerization of the epoxide cannot be used. Examples of suitable Lewis acids include, but are not limited to, [(ClTPP)Al(THF)₂]⁺ (ClTPP=meso-tetra(4-chlorophenylporphyrinato); THF=tetrahydrofuran), [(salph)Al(THF)₂]⁺ (salph=N,N′-bis(3,5-di-tert-butylsalicylidine-1,2-phenylenediamine), [(salph)Cr(THF)₂]⁺, [(OEP)Cr(THF)₂]⁺ (OEP=octaethylporphyrinato), [(TPP)Cr(THF)₂]⁺, and combinations thereof.

A broad range of polymerization catalysts can be used in the present invention. However, in the case where the carbonylation catalyst is [LA⁺][Co(CO)₄⁻] as described in the examples above a highly active distannate polymerization catalyst cannot be used. Examples of suitable polymerization catalysts include, but are not limited to organozinc compounds. Examples of organozinc compounds include, but are not limited to, (BDI)ZnOR¹ (BDI=β-diiminate), alkylzinc alkoxide compounds.

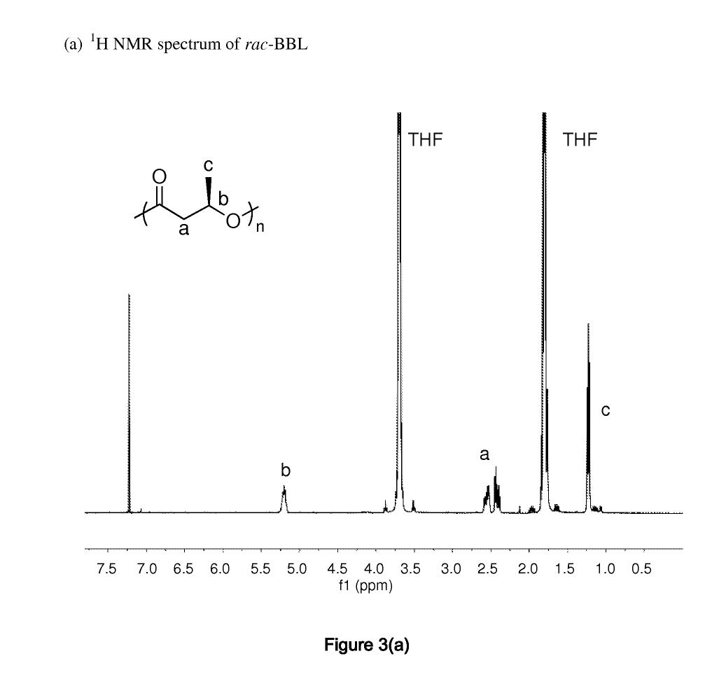

In the case of (BDI)ZnOR¹, BDI is a β-diiminate ligand. R¹ is an alkyl group or aryl group. The R¹ alkyl group can have from 1 carbon to 20 carbons, including all integer number of carbons and ranges therebetween. The alkyl group can be linear or branched and/or substituted or unsubstituted. For example, the alkyl groups can be substituted with one or more halogen atoms. The aryl group can have from 3 carbons to 8 carbons, including all integer number of carbons and ranges therebetween. Additionally, the aryl group can be substituted or unsubstituted. For example, the aryl group can be substituted with an alkyl group and/or one or more halogen atoms. Examples of Zn-BDI compounds are shown in FIG. 2 and Examples 2 and 3.

In the case of alkylzinc alkoxide compounds, e.g, R²ZnOR³, the alkyl group (e.g., R²) can be linear or branched and have from 1 carbon to 20 carbons, including all integer number of carbons and ranges therebetween, and the alkyl moiety of the alkoxy group (e.g., R³) can have from 1 carbon to 20 carbons, including all integer number of carbons and ranges therebetween. The alkyl groups and aryl groups can be substituted or unsubstituted. For example, the alkyl groups and aryl groups can be substituted with one or more halogens. A suitable example of an alkylzinc alkoxide compound is ethylzinc isopropoxide.

Other examples of polymerization catalysts include compounds having the following structure:

[C⁺][A⁻].

C⁺ is a cation. A⁻ is a nucleophillic anion.

Suitable cations include, but are not limited to, organic cations and ligated metal cations. Examples of suitable organic cations include, but are not limited to tetraalkyl ammonium, imidazolium, bis(triphenylphosphene)iminium (PPN), and phosphazenium cations. For example, the alkyl groups can have from 1 carbon to 20 carbons, including all integer numbers of carbons and ranges therebetween. The alkyl groups can be linear or branched and/or substituted or unsubstituted. For example, the alkyl groups can be substituted with one or more halogen atoms. Examples of ligated metal cations include, for example, ligated transition metal compounds.

The ligated metal cations can be ligated transition metal cations. Examples of suitable ligated transition metal cations include, but are not limited to, bipyridine ligated copper (I) and (II) cations, and pyridine ligated cobalt(salen) (III) cations. The ligated metal cations can be ligated alkali metal cations. Examples of suitable ligated alkali metal cations include, but are not limited to, alkali metal ions (e.g., Li⁺, Na⁺, and K⁺) that are ligated by a cyclic polyether of the form (CH₂CH₂O)ₙ, where n is, for example, 4-6.

A broad range of nucleophillic anions can be used. Examples of suitable nucleophillic anions include, but are not limited to, compounds (e.g., polymers and discrete molecules) comprising at least one carboxylate group, at least one alkoxide group, at least one phenoxide group, and combinations thereof. For example, the nucleophillic anion compounds can be polymers comprising at least one carboxylate, at least one alkoxide, at least one phenoxide moiety (e.g., —C(O)O⁻, —C—O⁻, -Ph-O⁻, respectively), or a combination thereof. In another example, the compounds can be discrete molecules comprising at least one carboxylate, at least one alkoxide, or at least one phenoxide moiety, or a combination thereof. In another example, the compounds are carboxylate compounds, alkoxide compounds, or phenoxide compounds (e.g., R—C(O)O⁻, —C—O⁻, -Ph-O⁻, respectively, where R is an alkyl group). For example, carboxylate compounds and alkoxide having alkyl groups comprising from 1 carbon to 20 carbons, including all integer numbers of carbons and ranges therebetween, can be used. The alkyl groups can be linear or branched and/or be substituted or unsubstitued. For example, the alkyl groups can be substituted with one or more halogen atoms. For example, the phenoxides can be substituted or unsubstituted. For example, the phenyl moiety of the phenoxide groups can be substituted with one or more alkyl groups (which can be branched and/or substituted) and/or one or more halogen atoms.

The carbonylation catalyst can be present in the reaction mixture at, for example, a concentration of from 0.1 mM to 0.2 M, including all values to the 0.1 mM and ranges therebetween. The polymerization catalyst can be present in the reaction mixture at, for example, a concentration of from 0.1 mM to 0.2 M, including all values to the 0.1 mM and ranges therebetween. The amount of either catalyst used is dependent on the activity of the catalyst. For example, a highly active catalyst will require a lower catalyst concentration to achieve a desired level of conversion, while a lower activity catalyst will require a higher catalyst concentration to achieve a desired level of conversion.

Reaction times and conditions (e.g., reaction temperature and carbon monoxide pressure) for the method can be varied to achieve the desired result. Generally, reaction times under 10 hours were observed. The reaction temperature can be from −25° C. to 150° C., including all integer values to the ° C. and ranges therebetween. The carbon monoxide can, for example, be present as a static atmosphere (e.g., a sealed reaction vessel) or as a stream (e.g., a flow-type reactor). The carbon monoxide pressure can be from 1 psi to 1500 psi, including all integer values to the psi and ranges therebetween. For example, the carbon monoxide pressure can be from 500 psi to 1200 psi. The carbonylation reaction and polymerization reaction can be allowed to proceed at the same or different temperatures. In an example, the reactions were run at 50° C. with 850 psi carbon monoxide.

In an embodiment, ethylene oxide (EO) can be used. For example, under nitrogen, a 100-mL Parr high-pressure reactor was charged with 0.01 mmol [ClTPPAl(THF)₂]⁺[Co(CO)₄]⁻ carbonylation catalyst, 20 mmol ethylene oxide, and 10 mL THF. The reactor was pressured to 850 psi CO followed by rapid stirring and heating to 50° C. After 5 hours the reactor was cooled to room temperature, slowly vented, and 0.1 mmol [PPM⁺ [OAc]⁻ (OAc=acetate) was injected. The reactor was stirred at room temperature for twelve hours. A small aliquot was removed for crude ¹H NMR analysis to determine monomer conversion. The viscous reaction mixture was then dissolved in a minimum amount of dichloromethane and precipitated into an excess of hexane. The polymer (poly(3-hydroxypropionate) was collected and dried in vacuo to give a purple (from residual porphyrin catalyst) solid. In another embodiment, poly(3-hydroxybutyrate) is prepared by carbonylation polymerization of propylene oxide.

In an embodiment, a copolymer can be produced. For example, under nitrogen, a 100-mL Parr high-pressure reactor was charged with 0.014 mmol [ClTPPAl(THF)₂]⁺[Co(CO)₄]⁻ carbonylation catalyst, 0.14 mmol [iPr(BDI)ZnOAc] polymerization catalyst, 14 mmol propylene oxide, 0.6 mmol of butene oxide, and 7 mL THF. The reactor was pressured to 850 psi CO followed by rapid stirring and heating to 50° C. After twelve hours, the reactor was cooled to room temperature, and slowly vented. A small aliquot was removed for crude ¹H NMR spectroscopic analysis to determine monomer conversion. The viscous reaction mixture was then dissolved in a minimum amount of dichloromethane and precipitated into an excess of hexane. The polymer poly((3-hydroxybutyrate-co-valerate)) was collected and dried in vacuo to give a purple (from residual porphyrin catalyst) solid.

In another aspect, the present invention provides a method for making a polymer comprising: reacting beta-propiolactone with a polymerization catalyst having the structure [C⁺][A⁻] as described herein, to form a polymer. In an embodiment, C⁺ is not a tetraethyl or tetra-n-butylammonium cation when A⁻ is a pivalate anion.

The following examples are presented to illustrate the present invention. They are not intended to be limiting in any manner.

### EXAMPLE 1

In this example, an example of an efficient method for the synthesis of poly(3-hydroxybutyrate) by the carbonylative polymerization of propylene oxide is described. The use of compatible epoxide carbonylation and lactone polymerizatcarion catalysts allows for a one-pot reaction that eliminates the need to isolate and purify the toxic beta-butyrolactone intermediate. (See FIG. 2.) Synthesis of P3HB via a one-pot tandem catalytic transformation, where BBL is synthesized from PO and CO and subsequently polymerized in situ (Scheme 1). A multicatalytic process eliminates the need to isolate and purify the toxic lactone monomer, while still maintaining the atom economy of the CO and PO copolymerization and providing the high-molecular weight polymer achieved by BBL polymerization. Tandem catalysis is a valuable method for synthesizing small molecules but has rarely been utilized for polymer synthesis.

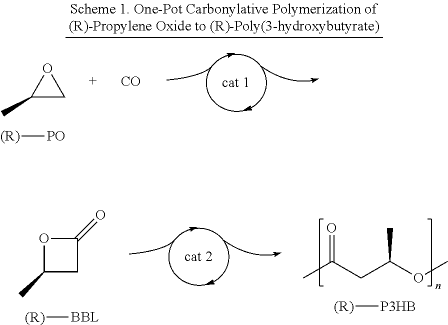

Developing a one-pot catalytic system is challenging, as the two catalysts must not only be compatible with each other, but also with the solvent, substrate, and reaction side-products in order to achieve high activity and selectivity. Catalysts of the form [Lewis acid]⁺[Co(CO)₄]⁻ is highly active for the carbonylation of epoxides and (BDI)ZnOⁱPr (BDI=β-diiminate) is an active catalyst for β-lactone polymerization. The orthogonal reactivity of these catalysts surprisingly combined to create an efficient system for the one-pot carbonylative polymerization of PO.

Four catalysts (complexes 1-4) were investigated for the carbonylation step of the one-pot reaction while using (BDI)ZnOⁱPr (5) for the polymerization (Scheme 2 and Table 1). Both complex 1 and complex 2 used with (BDI)ZnOⁱPr resulted in incomplete conversions for the carbonylation and polymerization reactions (entries 1 and 2). Catalyst 3 used with 5 completely transformed PO to BBL, but resulted in incomplete conversion of BBL to P3HB (entry 3). Finally, complex 4 [(ClTPP)Al(THF)₂]⁺[Co(CO)₄]⁻ (ClTPP=meso-tetra(4-chlorophenyl)porphyrinato) used with 5 showed high activities for both the carbonylation and polymerization stages of the reaction, respectively (entry 4).

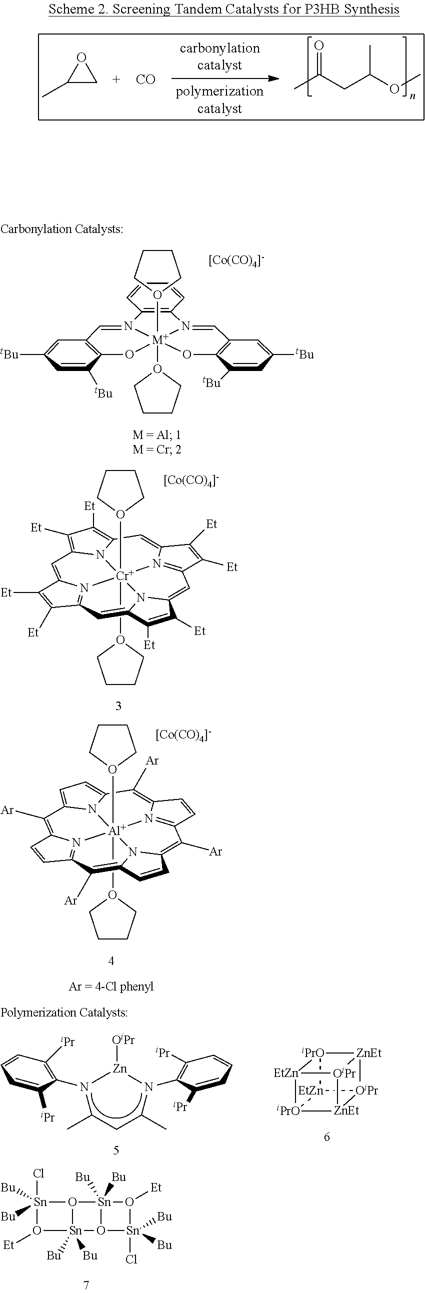

Equipped with a highly efficient and selective carbonylation catalyst for the one-pot synthesis of P3HB, two additional polymerization catalysts were investigated. Complexes 6 and 7 were selected. Ethylzinc isopropoxide (6) was a poor catalyst for this system, as it resulted in incomplete conversions for both reactions (entry 5). Distannoxane 7, impeded the carbonylation catalyst such that no BBL was formed (entry 4). The original polymerization catalyst (5) was the most efficient and selective of the three catalysts studied.

TABLE 1
Optimization of One-Pot P3HB Synthesis^{a}

| | carbonylation | polymerization | product dist. (%) | | |
|---|---|---|---|---|---|
| entry | catalyst | catalyst | PO | BBL | P3HB |
| 1 | 1 | 5 | 66 | 5 | 29 |
| 2 | 2 | 5 | 7 | 9 | 84 |
| 3 | 3 | 5 | — | 10 | 90 |
| 4 | 4 | 5 | — | 1 | 99 |
| 5 | 4 | 6 | 10 | 64 | 26 |
| 6 | 4 | 7 | >99 | <1 | <1 |

^{a}Reaction conditions: 0.1 mol % carbonylation catalyst, 0.1 mol % polymerization catalyst, [PO] = 2.0M in THF, 850 psi CO, 10 h, 50° C. Product distribution determined by ¹H NMR of crude reaction.

Minor changes in the sterics and electronics of the BDI zinc catalysts have significant effects on their activity. Alternative BDI zinc complexes and reaction conditions were investigated to further refine the one-pot carbonylative polymerization of PO (Table 2). Although complex 5, in combination with 4, proceeded to desirable conversion of P3HB, the molecular weight of the isolated polyester was low (entry 1). Complexes 8 and 9 with catalyst 4 resulted in incomplete formation of P3HB (entries 2 and 3). Complexes 10 and 11 used with 4 displayed both high activities and produced high molecular weight polymer (entries 4-7).

Under the reaction conditions of entry 4, the number-average molecular weight (Mₙ) of the polymer grew linearly with conversion and the polydispersity remained narrow throughout the reaction, suggesting living behavior. Naturally occurring P3HB is isotactic with all stereocenters in the (R) configuration, resulting in semicrystalline morphology. To produce isotactic P3HB, (R)-PO was carbonylatively polymerized (R)-PO to (R)-P3HB with a molecular weight of 43 kDa (entry 5). Complex 11 with 4 made polymer with a lower Mₙ (entry 6) than complex 10 with 4 under the same conditions and we attribute this to decomposition of the polyester under prolonged exposure to the reaction environment. Finally, we decreased the moles of 4 and 11 to roughly double Mₙ, and synthesized (R)-P3HB with a molecular weight of 52 kDa in 10 hours using 0.5 mol % catalyst 4 and 0.05 mol % catalyst 11 at 50° C. (entry 7).

TABLE 2
Examples of β-Diiminate Zinc Polymerization Catalysts^{a}

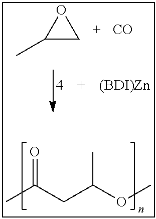

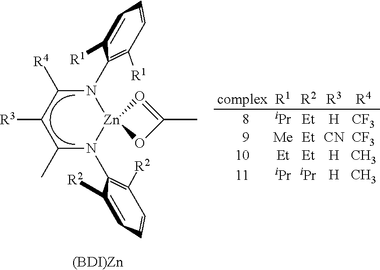

| | (BDI)Zn | [PO] | time | | P3HB | Mₙ | |
|---|---|---|---|---|---|---|---|
| entry | (mol %) | (M) | (h) | BBL (%) | (%) | (kDa) | PDI |
| 1 | 5 (1.0) | 3 | 10 | 1 | 99 | 7^{b} | 1.5 |
| 2 | 8 (1.0) | 3 | 15 | 29 | 55 | 4 | 1.1 |
| 3 | 9 (1.0) | 3 | 15 | 2 | 41 | 2 | 1.2 |
| 4 | 10 (1.0) | 2 | 6 | <1 | >99 | 38^{b} | 1.3 |
| 5 | 10 (1.0) | 2^{c} | 6 | <1 | >99 | 43^{d} | 1.1 |
| 6 | 11 (1.0) | 2 | 10 | <1 | >99 | 25^{b} | 1.3 |
| 7^{e} | 11 (0.5) | 2^{c} | 10 | <1 | >99 | 52^{d} | 1.1 |

^{a}General conditions: 0.1 mol % 4, Tᵣₓₙ = 50° C. Product distribution determined by ¹H NMR of crude reaction.
^{b}Mₙ and PDI values determined by GPC in THF with polystyrene standards.
^{c}(R)—PO.
^{d}Mₙ and PDI values determined by GPC in CHCl₃ vs. polystyrene standards.
^{e}0.05 mol % 4.

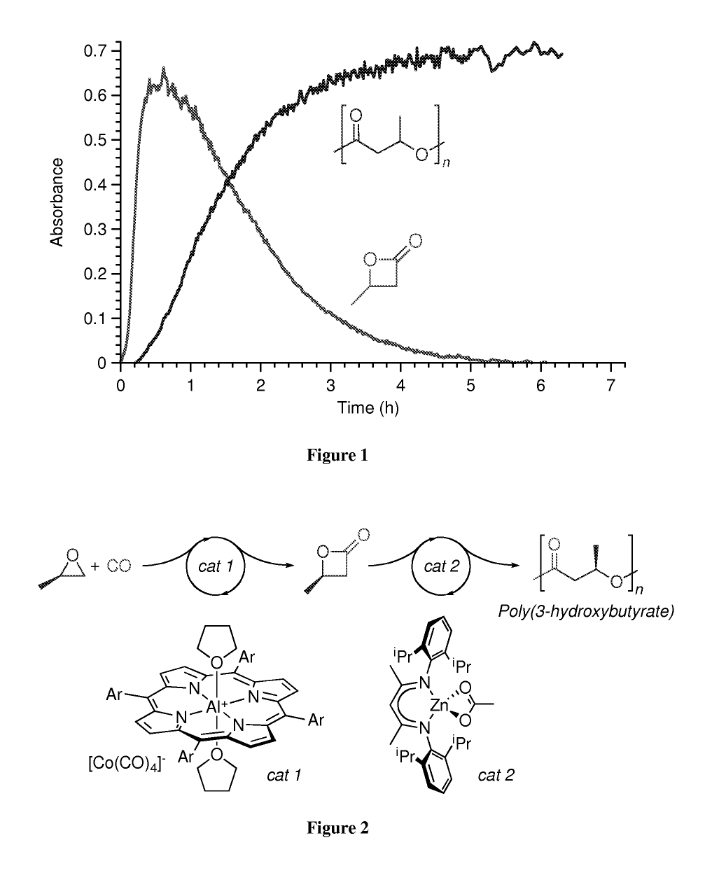

To confirm that the reaction proceeded by a two-step mechanism, the reaction was monitored by in situ IR spectroscopy. A plot of absorbance as a function of time confirmed formation of the BBL intermediate that subsequently was consumed to produce P3HB (FIG. 1).

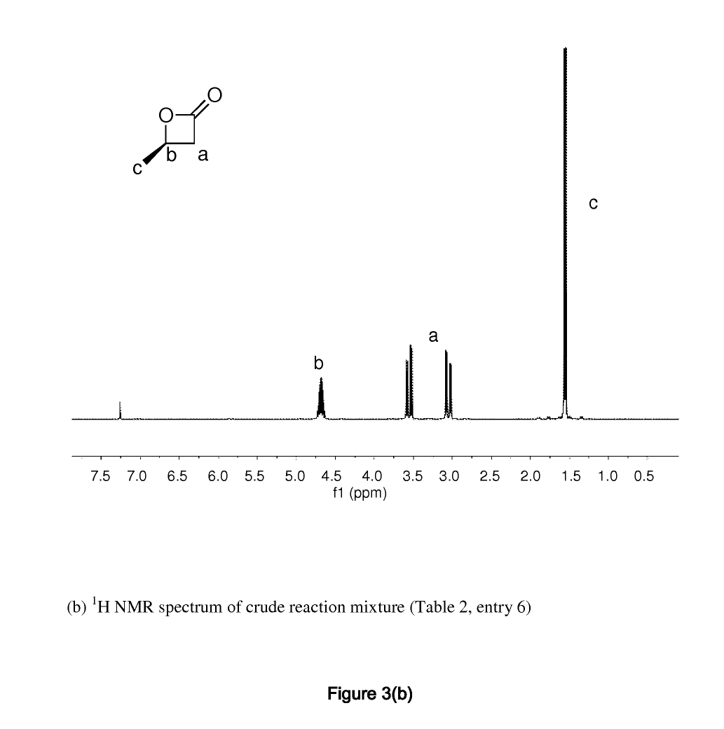

Exposure to the toxic BBL molecule can be eliminated by using tandem catalysis. In order to ensure the lactone was completely transformed over the course of the reaction, we used ¹H NMR spectroscopy and gas chromatography to verify the absence of BBL in the crude product (FIGS. 3(a)-(d)).

A new atom-economical and efficient method for the synthesis of P3HB from the carbonylative polymerization of propylene oxide was demonstrated. The use of compatible catalysts allows for a one-pot reaction that eliminates the need to isolate and purify the toxic BBL intermediate.

### General Considerations

All manipulations of air and water sensitive compounds were carried out under dry nitrogen using a Braun Labmaster glovebox or standard Schlenk line techniques. ¹H NMR spectra were recorded on a Varian Mercury (¹H, 300 MHz) or Varian INOVA 400 (¹H, 400 MHz) spectrometers and referenced with residual non-deuterated solvent shifts (CHCl₃=7.26 ppm). In situ IR data were collected using a 100-mL Parr stainless steel high-pressure reactor modified for use with a Mettler-Toledo ReactIR 4000 Reaction Analysis System fitted with a Sentinel DiComp high-pressure probe, and analyzed with ReactIR software version 2.21. Gas chromatography (GC) analyses were carried out using a Hewlett-Packard 6890 series gas chromatograph using a HP-5 (Crosslinked 5% PH ME Siloxane) capillary column (30 m×0.32 mm), a flame ionization detector, and He carrier gas.

Polymer Characterization. Gel permeation chromatography (GPC) analyses were carried out using a Waters instrument, (M515 pump, 717+ Autosampler) equipped with a Waters UV486 and Waters 2410 differential refractive index detectors, and three 5 (m PSS SDV columns (Polymer Standards Service; 50 Å, 500 Å, and Linear M porosities) in series. The GPC columns were eluted with tetrahydrofuran or chloroform at 40° C. at 1 mL/min and were calibrated using 20 monodisperse polystyrene standards.

Materials. Propylene oxide (PO) was dried over calcium hydride and vacuum transferred before use. Tetrahydrofuran was dried by passing over columns of alumina and degassed via repetitive freeze-pump-thaw cycles. (R)-Propylene oxide was prepared from the hydrolytic kinetic resolution of rac-propylene oxide. All other reagents were purchased from commercial sources and used as received. [(salph)Al(THF)₂]⁺[Co(CO)₄]⁻ (1), [(salph)Cr(THF)₂]⁺[Co(CO)₄]⁻ (2), [(OEP)Cr(THF)₂]⁺[Co(CO)₄]⁻ (3), [(TPP)Cr(THF)₂]⁺[Co(CO)₄]⁻ (4), [(BDI)ZnOⁱPr] complex 5, ethylzinc isopropoxide (6), distannoxane complex 7, and [(BDI)ZnOAc] complexes 8-11 were synthesized according to literature procedures.

Representative Carbonylative Polymerization Procedure. Under nitrogen, a 100-mL Parr high-pressure reactor was charged with 14 (mol carbonylation catalyst, 0.14 mmol polymerization catalyst, 29 mmol propylene oxide, and 14 mL THF. The reactor was pressured to 850 psi CO followed by rapid stirring and heating to 50° C. After the appropriate time, the reactor was cooled to room temperature, and slowly vented. A small aliquot was removed for crude ¹H NMR analysis to determine monomer conversion. The viscous reaction mixture was then dissolved in a minimum amount of dichloromethane and precipitated into an excess of hexane. The polymer was collected and dried in vacuo to give a purple (from residual porphyrin catalyst) solid typically in 90-95% recovery by weight.

### Characterization of Crude Reaction Mixture

The crude reaction mixture was first analyzed by ¹H NMR spectroscopy to determine the percent monomer conversion to poly(3-hydroxybutyrate) (P3HB) (a), (b). Next, the crude reaction mixture was analyzed by gas chromatography in order to confirm the absence of (-butyrolactone (BBL) (c), (d). PO was not detected in the ¹H NMR spectra of the reaction mixture aliquots.
Plot of Mₙ, vs. Conversion of BBL (Table 2, entry 4)

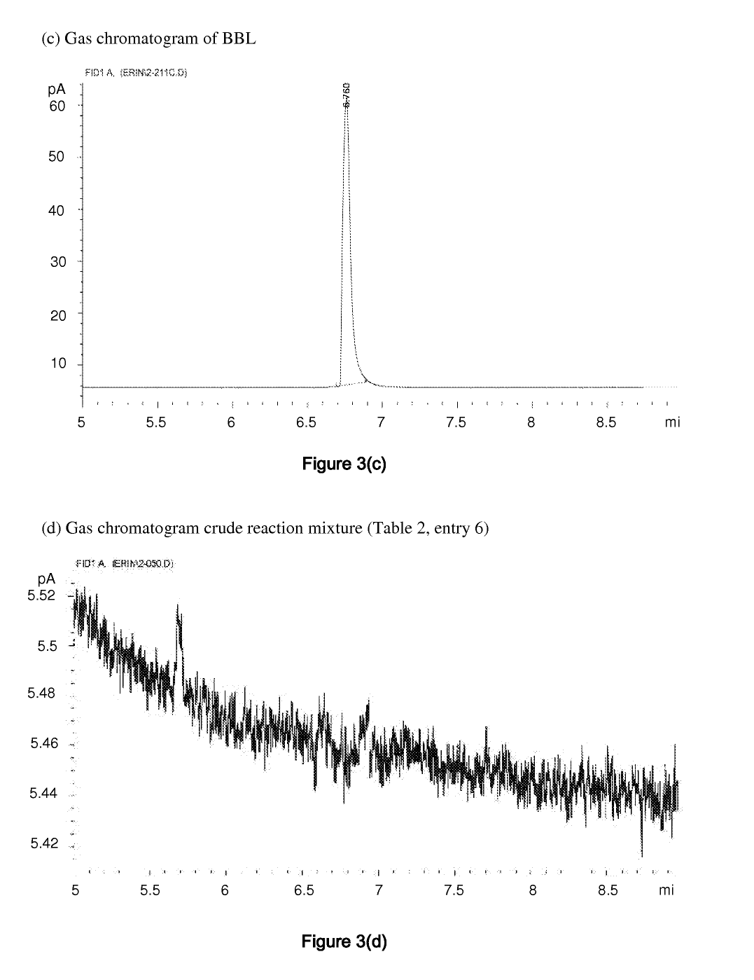

See FIG. 4.

### EXAMPLE 2

An example of a one-pot, 2-step reaction of EO and CO, the polymerization of beta-propiolactone using [C+][A⁻] ionic species. The process carbonylates epoxides to beta lactones, and once the lactone has formed, a polymerization catalyst is added to make poly(beta-hydroxyalkanoate)s in one pot but 2 steps from epoxides and CO. An example of the process is shown in the following reaction:

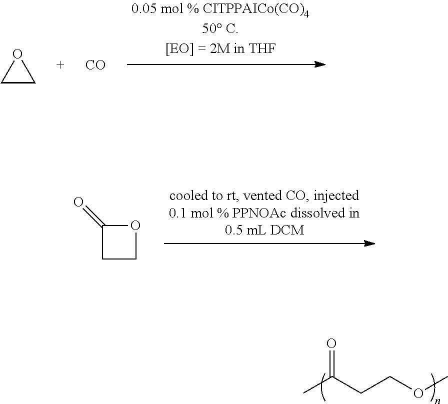

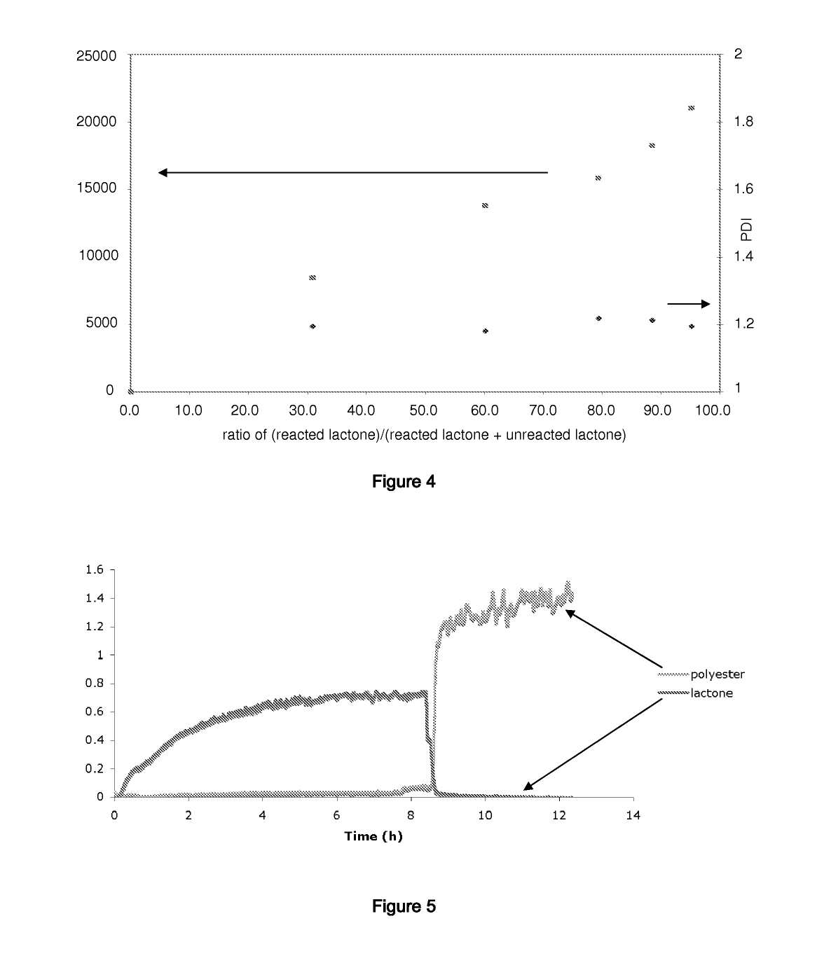

which provided 86% conversion, a Mn=14,600 g/mol and PDI=1.4. The theoretical Mn is 62,000 g/mol. FIG. 5 shows the formation of the lactone and subsequent formation of the polymer as determined by in situ IR spectroscopy.

### EXAMPLE 3

An example of polymerization of propiolactone (PL) with different polymerization catalysts. The data for the reactions is shown in Table 3. In Table 3, the following abbreviations are used:

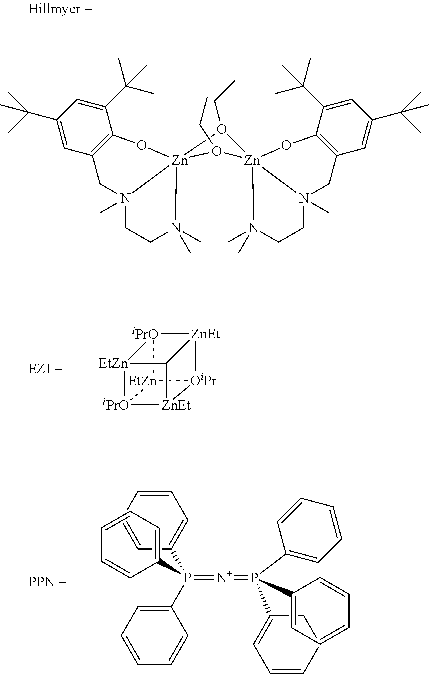

TABLE 3
Data for catalytic polymerization of propiolactone.

| | | | | | time | % | Mn | | |
|---|---|---|---|---|---|---|---|---|---|
| Catalyst | M/cat | [monomer] | solvent | Temp. | (min) | conv | (theo) | Mn | PDI |
| Et₄BDI(Zn)OAc | 200 | 3.8 | C₆D₆ | 24 | 70 | 3 | 14,400 | | |
| iPr₄BDI(Zn)OAc | 200 | 3.8 | C₆D₆ | 24 | 70 | 11 | 14,400 | | |
| iPr₄BDI(Zn)OⁱPr | 200 | 3.8 | C₆D₆ | 24 | 5 | >99 | 14,400 | | |
| iPr₂,Et₂BDI(Zn)OⁱPr | 200 | 3.8 | C₆D₆ | 24 | 5 | 0 | 14,400 | | |
| Et₄BDI(Zn)OⁱPr | 200 | 3.8 | C₆D₆ | 24 | 5 | 0 | 14,400 | | |
| Hillmyer | 200 | 3.8 | C₆D₆ | 24 | 5 | 32 | 14,400 | | |
| EZI | 200 | 3.8 | C₆D₆ | 24 | 5 | 0 | 14,400 | | |
| PPNOAc | 200 | 3.8 | C₆D₆ | 24 | 5 | 99 | 14,400 | 22,200 | 1.7 |
| PPNOBz | 200 | 3.8 | C₆D₆ | 24 | 5 | >99 | 14,400 | 23,800 | 1.6 |
| 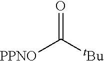 | 200 | 3.8 | C₆D₆ | 24 | 5 | 98 | 14,400 | | |
| 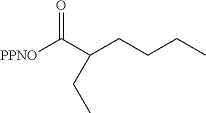 | 200 | 3.8 | C₆D₆ | 24 | 60 | 60 | 14,400 | | |
| ⁿBu₄NOAc | 200 | 3.8 | C₆D₆ | 24 | 5 | >99 | 14,400 | | |
| BnNMe₃OAc | 200 | 3.8 | C₆D₆ | 24 | 5 | 36 | 14,400 | | |
| 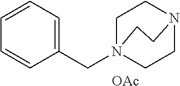 | 200 | 3.8 | C₆D₆ | 24 | 5 | 15 | 14,400 | | |
| 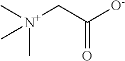 | 200 | 3.8 | C₆D₆ | 24 | 5 | 2 | 14,400 | | |
| PPNOAc | 400 | 3.8 | C₆D₆ | 24 | 8 | 96 | 28,500 | 23,400 | 1.9 |
| PPNOAc | 1000 | 3.8 | C₆D₆ | 24 | 20 | 93 | 71,300 | 46,200 | 1.7 |
| PPNOAc | 1000 | 3.8 | C₆D₆ | 0 | 360 | 97 | 71,300 | 44,900 | 2.4 |
| PPNOAc | 1500 | 3.8 | C₆D₆ | 24 | 60 | 93 | 108,000 | 53,850 | 2.0 |

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1) A method for making a polymer comprising:
reacting one or more epoxides, carbon monoxide, and a carbonylation catalyst to form one or more lactones, and allowing the one or more lactones to react with a polymerization catalyst, without isolation or purification of the one or more lactones, to form a polymer.

2) The method of claim 1, wherein the one or more epoxides are present in a solvent.

3) The method of claim 2, wherein the solvent is selected from tetrahydrofuran, diethylether, chloroform, dichloromethane, benzene, toluene, 1,4-dioxane, and combinations thereof.

4) The method of claim 1, wherein the carbon monoxide is at least partially removed after formation of the one or more lactones.

5) The method of claim 1, wherein the polymerization catalyst is added after at least 50% of the one or more epoxides is reacted to form the one or more lactones and the carbon monoxide is, optionally, removed.

6) The method of claim 1, wherein the method is carried out in a single reaction vessel.

7) The method of claim 1, wherein the one or more epoxides are selected from ethylene oxide, propylene oxide, butene oxide, hexene oxide, styrene oxide, trifluoromethyl ethylene oxide, a glycidyl ether, and combinations thereof.

8) The method of claim 1, wherein the one or more epoxides are ethylene oxide and propylene oxide, or propylene oxide and 1-butene oxide.

9) The method of claim 1, wherein the one or more epoxides are present in optically enriched form or in the form of a racemic mixture of epoxides.

10) The method of claim 1, wherein the carbonylation catalyst is a transition metal compound having the following structure:
[LA⁺][Co(CO)₄⁻],
wherein LA⁺ is a Lewis acid cation.

11) The method of claim 10, wherein LA⁺ is selected from [meso-tetra(4-chlorophenylporphyrinato)Al⁺], [meso-tetra(4-chlorophenylporphyrinato)Al(THF)₂⁺], [(salph)Al(THF)₂⁺], [(salph)Cr(THF)₂⁺], [(OEP)Cr(THF)₂⁺], [(TPP)Cr(THF)₂⁺].

12) The method of claim 1, wherein the polymerization catalyst is (BDI)ZnOR¹, wherein BDI is a β-diiminate ligand and R¹ is a C₁-C₂₀ alkyl, or an alkylzinc alkoxide compound.

13) The method of claim 5, wherein the polymerization catalyst is (BDI)ZnOR¹, wherein BDI is a β-diiminate ligand and R¹ is a C₁-C₂₀ alkyl, or an alkylzinc alkoxide compound.

14) The method of claim 5, wherein the epoxide is ethylene oxide, and the polymerization catalyst has the following structure:
[C⁺][A⁻],
wherein C⁺ is an organic cation or ligated metal cation, and wherein A⁻ is a nucleophilic anion.

15) The method of claim 14, wherein the organic cation is selected from tetraalkyl ammonium cations, imidazolium cations, bis(triphenylphosphene)iminium cations, and phosphazenium cations.

16) The method of claim 14, wherein the ligated metal cation is an alkali metal ion that is ligated by a cyclic polyether of the form (CH₂CH₂O)ₙ, where n is 4-6.

17) The method of claim 14, wherein the nucleophillic anion is selected from compounds comprising at least one carboxylate group, at least one alkoxide group, at least one phenoxide group, and combinations thereof.

18) A method for making a polymer comprising the steps of:
reacting beta-propiolactone with a polymerization catalyst having the following structure:
[C⁺][A⁻],
wherein C⁺ is an organic cation or ligated metal cation, and
wherein A⁻ is a nucleophillic anion,
with the proviso C⁺ is not a tetraethyl or tetra-n-butylammonium cation when A⁻ is a pivalate anion,
wherein a polymer is formed.

19) The method of claim 18, wherein the organic cation is selected from tetraalkyl ammonium cations, imidazolium cations, bis(triphenylphosphene)iminium cations, and phosphazenium cations.

20) The method of claim 18, wherein the nucleophillic anion is selected from compounds comprising at least one carboxylate group, at least one alkoxide group, at least one phenoxide group, and combinations thereof.
